(19) United States
(12) Patent Application Publication
(10) Pub. No.: US 2016/0209351 A1
(43) Pub. Date: Jul. 21, 2016

(54) SENSOR

(71) Applicant: NGK Spark Plug Co., LTD., Nagoya (JP)

(72) Inventors: Takehiro OBA, Kounan (JP); Shingo ITO, Ichinomiya (JP); Shogo NAGATA, Komaki (JP)

(73) Assignee: NGK Spark Plug Co., LTD., Nagoya (JP)

(21) Appl. No.: 14/991,697

(22) Filed: Jan. 8, 2016

(30) Foreign Application Priority Data
Jan. 9, 2015 (JP) 2015-002894
Nov. 30, 2015 (JP) 2015-232951

(51) Int. Cl. G01N 27/406; G01N 27/407

(52) U.S. Cl. CPC G01N 27/4062; G01N 27/407

(57) ABSTRACT

A sensor includes a metal terminal member that is electrically connected to an electrode terminal portion and forms a current path. The electrode terminal member includes: an elongated frame body portion extending in the axial direction; an inward extending portion connected to a front end portion of the frame body portion and extending from the frame body portion toward a side where the detection element is located; a spring portion connected to an inward end portion, which is an end of the inward extending portion located on the side of the detection element, the spring portion extending toward the rear side in the axial direction and intersecting the axial direction; and an element contact portion formed in the spring portion, and contacting the electrode terminal portion.

This application claims the benefit of Japanese Patent Applications No. 2015-002894, filed Jan. 9, 2015 and No. 2015-232951, filed Nov. 30, 2015, all of which are incorporated herein by reference in their entity.

### FIELD OF THE INVENTION

The present invention relates to sensor technologies.

### BACKGROUND OF THE INVENTION

Conventionally, a sensor used for detecting the concentration of a specific gas component such as oxygen or NOX contained in exhaust gas of a motor vehicle or the like has been known (Japanese Laid-Open Patent Publication No. 2013-181769 and Japanese Laid-Open Patent Publication No. 2004-93302, for example). This sensor includes: a detection element having a plate shape extending in an axial direction, and including a detection portion at a front side thereof and an electrode terminal portion made of a noble metal such as Pt at a rear side thereof; a metal terminal member electrically connected to the electrode terminal portion and forming a current path; and a separator into which the metal terminal member is inserted (Japanese Laid-Open Patent Publication No. 2013-181769 and Japanese Laid-Open Patent Publication No. 2004-9330, for example).

The conventional metal terminal member includes: an elongated frame body portion extending in an axial direction; and a spring portion folded back from a front end of the frame body portion toward a rear end thereof in the axial direction. In the spring portion, an element contact portion contacting the electrode terminal portion is formed. In a process of manufacturing the sensor, when the detection element is inserted along the axial direction into the separator in which the metal terminal member is inserted, the spring portion is pressed by the detection element and elastically deformed. Eventually, the element contact portion comes into contact with the electrode terminal portion. The spring portion in the state of being assembled in the sensor is, as compared to that in the free state, elastically deformed toward the frame body portion around the front end of the frame body portion as a fulcrum. Due to the function of the elastic deformation, the element contact portion presses the electrode terminal portion to prevent these portion from being in the non-contact state, thereby maintaining the electrical connection.

### PROBLEMS TO BE SOLVED BY THE INVENTION

However, when the cross-sectional shape of the spring portion and the frame body portion is a so-called V shape as in the conventional metal terminal member described in Japanese Laid-Open Patent Publication No. 2013-181769 and Japanese Laid-Open Patent Publication No. 2004-9330, the degree of folding of the spring portion (a folding angle formed by the frame body portion and the spring portion) may be low, and an angle A (A is not larger than 90 degrees) formed by a direction in which the spring portion in the free state extends (a longitudinal direction of the spring portion) and the axial direction may be increased. Such an increase in the angle A causes an increase in the amount of movement of the element contact portion along the axial direction when the spring portion is pressed by the detection element and elastically deformed toward the frame body portion side in the sensor manufacturing process. Therefore, in order to reliably achieve contact between the electrode terminal portion and the element contact portion, the electrode terminal portion needs to be formed large in size along the axial direction, taking into account the amount of movement. If the size of the electrode terminal portion is increased, the manufacturing cost of the entire sensor may be increased.

Meanwhile, in order to reduce the angle A, a technique is also conceivable in which the front end of the frame body portion is further extended toward the front side in the axial direction to increase the degree of folding of the spring portion. In this case, however, since the metal terminal member is located at a position closer to a heat source such as exhaust gas from a combustion engine, a drawback such as variation in characteristics (e.g., spring elasticity) of the metal terminal member due to heat may occur. Further, in this case, in order to locate the element contact portion in a predetermined contact region between the electrode terminal portion and the element contact portion in the sensor, the length of the spring portion needs to be increased. If the length of the spring portion is further increased, the pressing force of the terminal contact portion to the electrode terminal portion may be reduced. If the pressing force is reduced, the electrical contact between the terminal contact portion and the electrode terminal portion may not be favorably maintained. Further, when the front end of the frame body portion is further extended toward the front side in the axial direction, the length of the sensor in the axial direction needs to be designed larger in order to avoid contact of the metal terminal member with other members (e.g., a metal shell) of the sensor, disposed on the front side relative to the metal terminal member. In this case, the sensor may be increased in size.

Meanwhile, when the cross-sectional shape of the spring portion and the frame body portion is a so-called U shape as in the metal terminal member described in Japanese Laid-Open Patent Publication No. 2004-9330, no inflection point exists in the frame body portion and the spring portion. Therefore, when insertion of the element is performed in the sensor manufacturing process, the amount of movement of the element contact portion is increased in association with movement of the element along the axial direction, whereby the position of contact with the element may be deviated from a predetermined position.

### SUMMARY OF THE INVENTION

### Means for Solving the Problems

The present invention has been made to solve the above problems and can be embodied in the following modes or applications.

(1) According to an aspect of the present invention, a sensor is provided which includes: a detection element having a plate shape extending in an axial direction, the detection element having a front side in the axial direction being directed to a measurement target, and a rear side in the axial direction on which an electrode terminal portion is formed; a separator having an insertion portion into which the rear side of the detection element is inserted, and a plurality of groove portions extending in the axial direction, formed on an inner wall surface of the insertion portion; and a metal terminal member that is held between the detection element and the separator while being inserted in at least one of the plurality of groove portions, and is electrically connected to the electrode terminal portion to form a current path. The metal terminal member of this sensor includes: an elongated frame body portion extending in the axial direction; an inward extending portion connected to a front end portion of the frame body portion, and extending from the frame body portion toward a side where the detection element is located; a spring portion connected to an inward end portion, which is an end of the inward extending portion on the side of the detection element, the spring portion extending toward the rear side in the axial direction and intersecting the axial direction; and an element contact portion formed in the spring portion, and contacting the electrode terminal portion.

According to the sensor of this aspect, since the metal terminal member has the inward extending portion located between the frame body portion and the spring portion and extending from the frame body portion toward the side where the detection element is located, an angle formed by a direction in which the spring portion in the free state extends and the axial direction can be reduced while suppressing an increase in the size of the metal terminal member in the axial direction. Thus, the amount of movement of the element contact portion along the axial direction when the electrode terminal portion is brought into contact with the element contact portion, can be reduced. Accordingly, the electrode terminal portion and the element contact portion can be brought into contact with each other while suppressing the dimension of the electrode terminal portion along the axial direction.

(2) In the sensor of the above aspect, the spring portion may have rigidity lower than that of the inward extending portion.

According to the sensor of this aspect, as compared to the case where the spring portion and the inward extending portion have the same rigidity, the amount of deformation of the inward extending portion can be suppressed even when the spring portion is elastically deformed by a force applied from the detection element. Thus, the amount of movement of the element contact portion along the axial direction when the electrode terminal portion is brought into contact with the element contact portion, can be reduced.

(3) In the sensor of the above aspect, the spring portion and the inward extending portion each may have a plate shape, and the spring portion may have a width smaller than that of the inward extending portion.

According to the sensor of this aspect, as compared to the case where the inward extending portion and the spring portion have the same width, the amount of deformation of the inward extending portion can be suppressed even when the spring portion is elastically deformed by a force applied from the detection element.

(4) In the sensor of the above aspect, a length of the spring portion in a longitudinal direction is longer than that of the inward extending portion.

According to the sensor of this aspect, as compared to the case where the inward extending portion and the spring portion have the same length along directions in which the inward extending portion and the spring portion extend, the amount of deformation of the inward extending portion can be suppressed even when the spring portion is elastically deformed by a force applied from the detection element.

(5) In the sensor of the above aspect, the inward extending portion may be a member linearly extending from the front end portion of the frame body portion.

According to the sensor of this aspect, the inward extending portion can be easily formed of a linearly extending member. The “linearly extending member” includes a member having a flat surface and extending straightly, and a member having a surface with unevenness caused by variations in manufacture.

(6) In the sensor of the above aspect, the inward extending portion may extend in either a direction orthogonal to the axial direction or a direction toward the rear side in the axial direction.

According to the sensor of this aspect, since the length of the metal terminal member in the axial direction can be suppressed, an increase in the size of the sensor can be suppressed.

(7) In the sensor of the above aspect, a relationship of (B1-B2)>(A1-A2) may be satisfied, where A1 is an angle formed by the frame body portion and the inward extending portion (0°<A1 <180°) in a free state, B1 is an angle formed by the inward extending portion and the spring portion (0°<B1 <180°) in a free state, A2 is an angle formed by the frame body portion and the inward extending portion (0°<A2 <180°) in a state where the metal terminal member is assembled as a component of the sensor and B2 is an angle formed by the inward extending portion and the spring portion (0°<B2 <180°) in a state where the metal terminal member is assembled as a component of the sensor.

According to the sensor of this aspect, since the relationship of (B1-B2)>(A1-A2) is satisfied, the amount of movement of the element contact portion along the axial direction when the element contact portion is brought into contact with the electrode terminal portion can be further reduced.

The present invention can be embodied in various forms other than the sensor. For example, the present invention can be embodied in forms such as a metal terminal member used in a sensor, a method for manufacturing a metal terminal member, and a method for manufacturing a sensor.

### BRIEF DESCRIPTION OF THE DRAWINGS

These and other features and advantages of the present invention will become more readily appreciated when considered in connection with the following detailed description and appended drawings, wherein like designations denote like elements in the various views, and wherein:

FIG. 1 is a cross-sectional view illustrating an overall structure of a sensor as an embodiment of the present invention.

FIG. 2 is an exploded perspective view of a detection element.

FIG. 3 is a first perspective view of a metal terminal member.

FIG. 4 is a front view of the metal terminal member.

FIGS. 5A-5C are diagrams for explaining the metal terminal member.

FIG. 6 is a perspective view in which the metal terminal member is disposed in a separator.

FIG. 7 is a diagram for explaining a method for manufacturing the sensor.

FIGS. 8A-8B are diagrams for explaining a metal terminal member included in a conventional sensor.

FIGS. 9A-9B are diagrams for explaining effects.

FIGS. 10A-10B are diagrams for more explaining the metal terminal member.

FIG. 11 is a perspective view of a metal terminal member according to first alternative embodiment.

FIGS. 12A-12D are schematic views for explaining second to fifth alternative embodiments of the metal terminal member.

### DETAILED DESCRIPTION OF THE INVENTION

A. Embodiment:

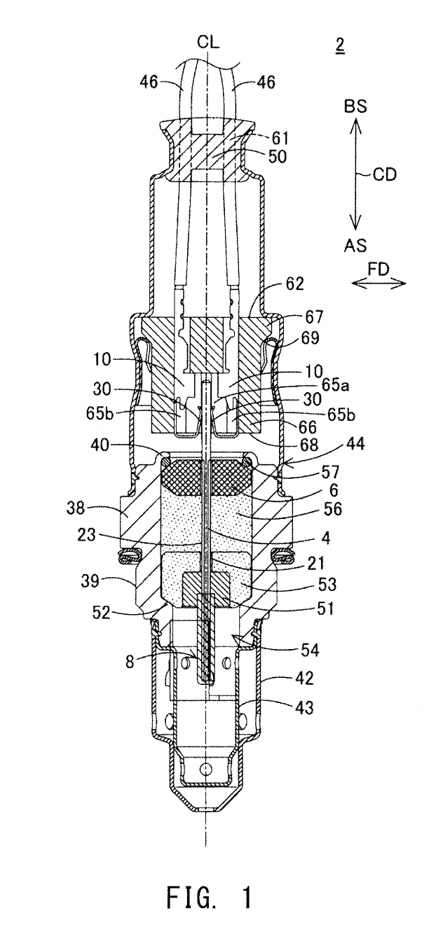

FIG. 1 is a cross-sectional view showing the overall structure of a sensor 2 according to an embodiment of the present invention. The sensor 2 is fixed to an exhaust pipe of an internal combustion engine (not shown), and measures the concentration of oxygen in exhaust gas which is gas to be measured. FIG. 1 shows a cross section of the sensor 2 parallel to an axial direction CD (the longitudinal direction of the sensor 2) which is a direction parallel to an axis CL of the sensor 2. Hereinafter, a downward direction (lower side) in FIG. 1 is referred to as a front side AS of the sensor 2, and an upward direction (upper side) in FIG. 1 is referred to as a rear side BS of the sensor 2.

The sensor 2 includes: a plate-shaped detection element 4 extending in the axial direction CD; a separator 66 into which a portion of the detection element 4 on the rear side BS is inserted; metal terminal members 10 contacting electrode terminal portions 30 of the detection element 4 which are formed on the rear side BS; and a metal shell 38 surrounding the circumference of the detection element 4 at a position on the front side AS relative to the separator 66. Four electrode terminal portions 30 and four metal terminal members 10 are provided. In FIG. 1, only two electrode terminal portions 30 and two metal terminal members are shown.

The detection element 4 outputs a signal for detecting the concentration of oxygen in exhaust gas which is gas to be measured. The detection element 4 has a first plate surface 21 and a second plate surface 23 each constituting a main surface. The first plate surface 21 and the second plate surface 23 oppose each other. A direction orthogonal to the axial direction CD, in which the first plate surface 21 and the second plate surface 23 oppose each other, is referred to as an opposing direction FD. The detection element 4 includes: a detection portion 8 located on the front side AS and directed to the gas to be measured; and the four electrode terminal portions 30 located on the rear side BS, with which the corresponding metal terminal members 10 are in contact. Two of the four electrode terminal portions 30 are formed on the first plate surface 21, and the remaining two electrode terminal portions 30 are formed on the second plate surface 23. The detection element 4 is fixed in the metal shell 38, with the detection portion 8 protruding from a front end of the metal shell 38 and the electrode terminal portions 30 protruding from a rear end of the metal shell 38. The detection element 4 will be described later in detail.

The separator 66 is formed of an insulating material such as alumina. The separator 66 has a substantially tubular shape. The separator 66 surrounds the circumference of a rear end portion of the detection element 4 in which the electrode terminal portions 30 are disposed. The separator 66 includes: an insertion portion 65a into which the rear end portion of the detection element 4 is to be inserted; and four groove portions (only two of them are shown in FIG. 1) formed on an inner wall surface of the insertion portion 65a. The four groove portions 65b extend in the axial direction CD and penetrate through the separator 66 from a front-side end surface 68 of the separator 66 to a rear-side end surface 62 thereof. The corresponding metal terminal members 10 are inserted into the four groove portions 65b. In addition, the separator 66 has, on the rear side BS, a flange portion 67 protruding outward in a radial direction.

The metal terminal members 10 are located between the detection element 4 and the separator 66 in the opposing direction FD, while being inserted into the corresponding groove portions 65b. The metal terminal members 10 are sandwiched and held between the detection element 4 and the separator 66. The metal terminal members 10 form a current path between the detection element 4 and an external device for calculating the concentration of oxygen. The metal terminal members 10 are electrically connected to lead wires 46 introduced into the sensor 2 from the outside, and are electrically connected to the electrode terminal portions 30 of the detection element 4. Four lead wires 46 are provided corresponding to the number of the electrode terminal portions 30, and are electrically connected to the external device (only two lead wires 46 are shown in FIG. 1).

The metal shell 38 has a substantially tubular shape. The metal shell 38 has a through-hole 54 penetrating through the metal shell 38 in the axial direction CD, and a ledge portion 52 protruding inward in a radial direction of the through-hole 54. The metal shell 38 holds the detection element 4 in the through-hole 54 so that the detection portion 8 is located on the front side AS relative to the through-hole 54, and the electrode terminal portions 30 are located on the rear side relative to the through-hole 54. The ledge portion 52 is formed as an inwardly tapered surface that is inclined with respect to a flat surface perpendicular to the axial direction CD. A screw portion 39 for fixing the sensor 2 to an exhaust pipe is formed at an outer surface of the metal shell 38.

In the through-hole 54, an annular ceramic holder 51, powder-charged layers 53, 56 (hereinafter also referred to as talc rings 53, 56), and a ceramic sleeve 6 are stacked in order from the front side AS to the rear side BS so as to surround the circumference of the detection element 4 in the radial direction. In addition, a crimping packing 57 is disposed between the ceramic sleeve 6 and a rear end portion 40 of the metal shell 38. The rear end portion 40 of the metal shell 38 is crimped via the crimping packing 57 so as to press the ceramic sleeve 6 toward the front side. In another embodiment, a metal holder for holding the talc ring 53 and the ceramic holder 51 to maintain airtightness may be disposed between the ceramic holder 51 and the ledge portion 52 of the metal shell 38.

The sensor 2 further includes: an outer casing 44 fixed to the circumference of the metal shell 38 on the rear side BS; a holding member 69 for holding the separator 66; a grommet 50 disposed at a rear end portion of the outer casing 44; and an outer protector 42 and an inner protector 43 fixed to the circumference of the metal shell 38 on the front side AS.

The outer casing 44 is a member made of metal. The circumference of the front end portion of the outer casing 44 is mounted to the metal shell 38 by laser beam welding or the like. The outer diameter of the rear end portion of the outer casing 44 is narrowed, and the grommet 50 is fitted in a narrowed opening of the outer casing 44. In the grommet 50, four lead wire insertion holes 61 (only two of them are shown in FIG. 1) through which the lead wires 46 are inserted are formed.

The holding member 69 is a tubular member made of metal. The holding member 69 is fixed to the outer casing 44 and positioned in the outer casing 44. The flange portion 67 of the separator 66 is in contact with the rear end portion of the holding member 69, whereby the separator 66 is held by the holding member 69.

The outer protector 42 and the inner protector 43 each have a bottomed tubular shape. The outer protector 42 and the inner protector 43 are mounted to the circumference of the metal shell 38 on the front side AS by laser beam welding or the like. The outer protector 42 and the inner protector 43 are metal members having a plurality of holes. The outer protector 42 and the inner protector 43 cover the detection portion 8 of the detection element 4 to protect the detection portion 8. The gas to be measured flows into the inner protector 43 through the plurality of holes.

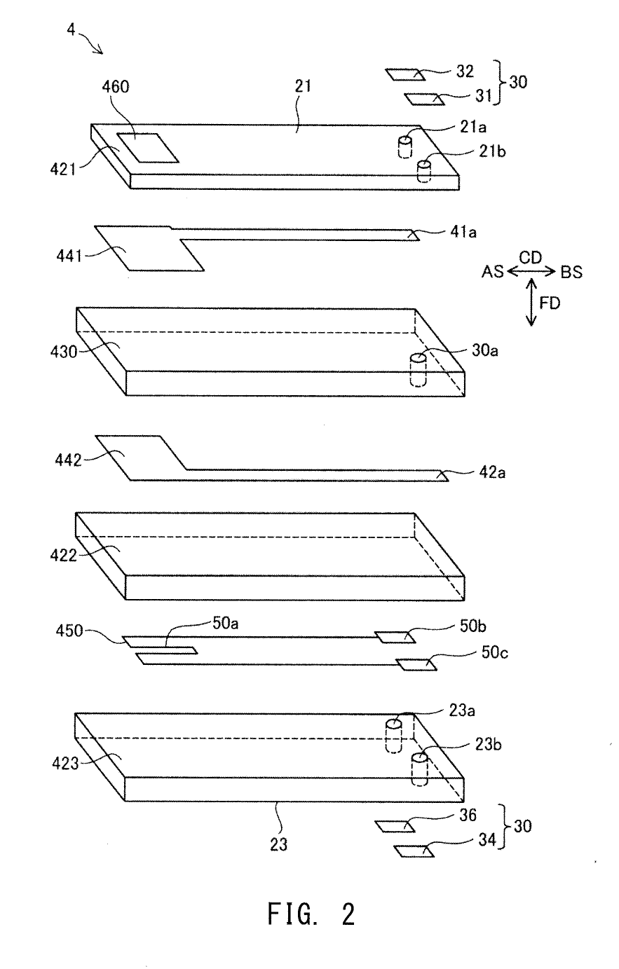

FIG. 2 is an exploded perspective view of the detection element 4. The detection element 4 includes an insulating layer 421, a solid electrolyte layer 430, an insulating layer 422, and an insulating layer 423. The insulating layer 421, the solid electrolyte layer 430, the insulating layer 422, and the insulating layer 423 are stacked along the opposing direction FD.

The solid electrolyte layer 430 is made of zirconia having oxygen ion conductivity as a principal component. To the solid electrolyte layer 430, yttria or calcia is added as a stabilizing agent.

The insulating layers 421, 422 and 423 are formed using alumina as a principal component. The solid electrolyte layer 430 and the insulating layers 421, 422 and 423 are formed using sheets of the raw material (e.g., sheets of ceramic such as zirconia or alumina).

A gas-to-be-measured side electrode 441 is disposed between the solid electrolyte layer 430 and the insulating layer 421, and a reference gas electrode 442 is disposed between the solid electrolyte layer 430 and the insulating layer 422. A sensing lead portion 41a extends from the gas-to-be-measured side electrode 441 to the rear side BS, and a sensing lead portion 42a extends from the reference gas electrode 442 to the rear side BS. The gas-to-be-measured side electrode 441 and the reference gas electrode 442 are formed by using platinum, rhodium, lead, or the like, for example.

Detection of the oxygen concentration in the exhaust gas as the gas to be measured is performed using an oxygen concentration cell as the detection portion 8 (FIG. 1). The oxygen concentration cell is composed of the solid electrolyte layer 430, the gas-to-be-measured side electrode 441, and the reference gas electrode 442. The gas-to-be-measured side electrode 441 is electrically connected to an electrode terminal portion 32 via the sensing lead portion 41a and a through-hole 21a formed through the insulating layer 421. The reference gas electrode 442 is electrically connected to an electrode terminal portion 31 via the sensing lead portion 42a, a through-hole 30a formed through the solid electrolyte layer 430, and a through-hole 21b formed through the insulating layer 421.

The insulating layer 421 has, on its front side, a porous protection layer 460 made of alumina or the like. The porous protection layer 460 is a porous layer provided for diffusing the gas (gas to be measured) that enters the gas-to-be-measured side electrode 441.

A heater 450 extending along the axial direction CD is embedded between the insulating layer 422 and the insulating layer 423. The heater 450 is used to heat the detection element 4 up to a predetermined activation temperature, thereby to increase conductivity of oxygen ions in the solid electrolyte layer and stabilize the operation of the sensor 2. The heater 450 is a heat generating resistor made of a conductor such as tungsten, and generates heat in response to a power supplied thereto. The heater 450 is sandwiched and held between the insulating layer 422 and the insulating layer 423.

The heater 450 includes a heat generating portion 50a and electrode terminals 50b and 50c. The heat generating portion 50a is located on the front side AS. In the heat generating portion 50a, a heat generating wire is arranged in a meandering manner, and generates heat when a voltage is applied thereto. The electrode terminals 50b, 50c of the heater 450 are electrically connected to electrode terminal portions 34, 36 via the through-holes 23a, 23b formed through the insulating layer 423, respectively. In the present embodiment, when the four electrode terminal portions 31, 32, 34 and 36 are referred to without being distinguished from each other, a reference numeral “30” is used.

The four electrode terminal portions 31, 32, 34 and 36 are formed at the rear end portion of the detection element 4. Specifically, two electrode terminal portions 31, 32 are formed on the first plate surface 21 so as to be aligned in a direction orthogonal to the axial direction CD and the opposing direction FD. Meanwhile, two electrode terminal portions 34, 36 are formed on the second plate surface 23 so as to be aligned in the direction orthogonal to the axial direction CD and the opposing direction FD. The electrode terminal portion 30 is made of a material containing platinum as a principal component. For example, the electrode terminal portion 30 is formed by screen-printing of a paste containing platinum as a principal component. The electrode terminal portion 30 may be formed by using other metals (e.g., rhodium, lead, etc.). The electrode terminal portion 30 has a substantially rectangular surface.

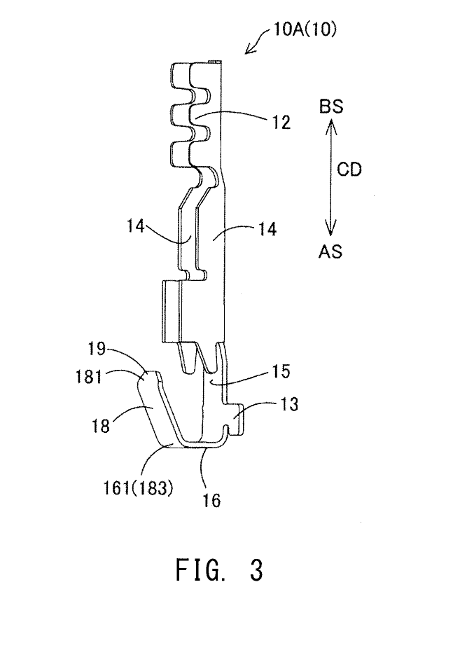

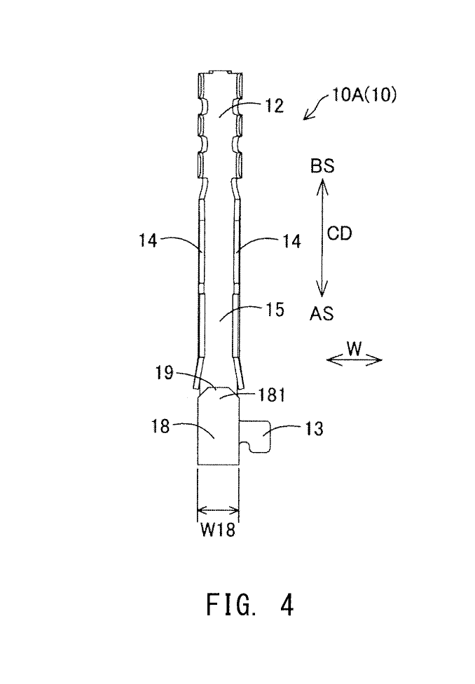

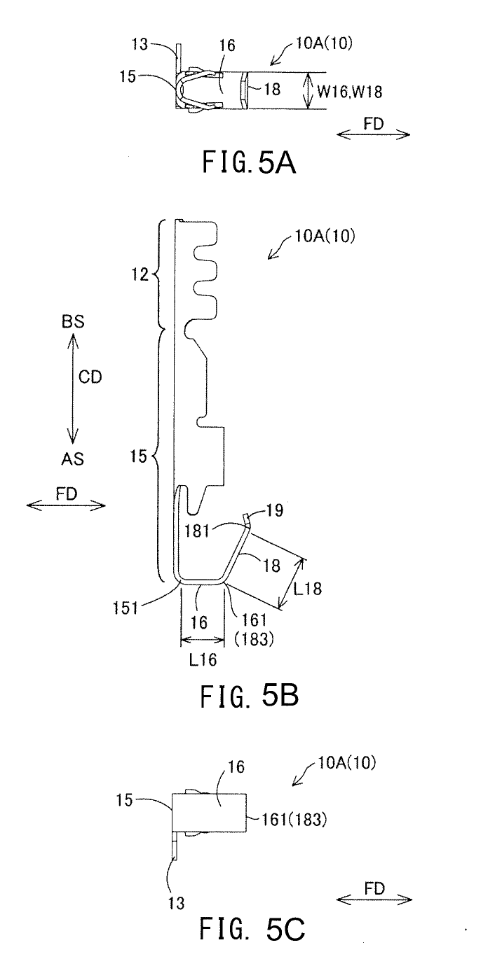

FIG. 3 is a first perspective view of the metal terminal member 10. FIG. 4 is a front view of the metal terminal member 10. FIGS. 5A-5 are diagrams for explaining the metal terminal member 10. FIG. 5A is a top view of the metal terminal member 10. FIG. 5B is a left side view of the metal terminal member 10. FIG. 5C is a bottom view of the metal terminal member 10. FIGS. 3 to 5 each show the metal terminal member 10 in the free state before being assembled as a component of the sensor 2. The four metal terminal members 10 included in the sensor 2 are classified into two types, i.e., a first-type metal terminal member 10A and a second-type metal terminal member 10B. The sensor 2 according to the present embodiment includes two first-type metal terminal members 10A and two second-type metal terminal members 10B. The first-type metal terminal member 10A and the second-type metal terminal member 10B are different from each other only in the position of an engagement portion 13 described later. Therefore, hereinafter, the first-type metal terminal member 10A will be described, and besides a specific structure of the second-type metal terminal member 10B will be described. When the first-type and second-type metal terminal members 10A, 10B are referred to without being distinguished from each other, they are referred to as “metal terminal member 10”.

The metal terminal member 10 (FIG. 3) includes a lead wire connecting portion 12, a frame body portion 15, an inward extending portion 16, a spring portion 18, and an element contact portion 181. The metal terminal member 10 is formed of metal such as INCONEL or stainless steel. The metal terminal member 10 is formed by subjecting a flat-plate-shaped metal member to processing such as pressing. That is, portions of the metal terminal member 10 described below are formed of a single common member. In another embodiment, the metal terminal member 10 may be formed of a combination of different members.

As shown in FIG. 4, the frame body portion 15 has an elongated shape extending in the axial direction CD. At the rear end of the frame body portion 15, the lead wire connecting portion 12 is provided integrally with the frame body portion 15. The lead wire connecting portion 12 is inwardly crimped with a core of the lead wire 46 being inserted therein, whereby the lead wire connecting portion 12 is connected to the lead wire 46. At both ends of the frame body portion 15 in a width direction W (the left-right direction of the sheet of FIG. 4), a pair of projecting portions 14 that projects in a direction approaching the detection element 4 are provided. Each of the projecting portions 14 is a plate member perpendicularly intersecting the plate surface of the frame body portion 15, and has, at a front end thereof, an engagement piece having a truncated chevron shape. The engagement piece of each projecting portion 14 is in contact with the wall surface of each groove portion 65b formed in the separator 66, whereby movement of the metal terminal member 10 in the groove portion 65b in the width direction W is regulated. The width direction W is a direction orthogonal to the axial direction CD and the opposing direction FD (FIG. 5B).

As shown in FIG. 3, in the frame body portion 15, the engagement portion 13 is provided at a position on the front side AS relative to the projecting portions 14. The engagement portion 13 is provided at one of both lateral end portions of the frame body portion 15 in the width direction W. The engagement portion 13 of the first-type metal terminal member 10A is provided on a right lateral end portion of the frame body portion 15 as viewed from front (FIG. 4). On the other hand, the second-type metal terminal member 10B is provided on a left lateral end portion of the frame body portion 15 as viewed from front. The engagement portion 13 is a plate-shaped member protruding outward in the width direction W from the frame body portion 15. The engagement portion 13 being engaged with the separator 66 prevents the frame body portion 15 from being deformed to the detection element 4 side.

The inward extending portion 16 (FIG. 5B) has a plate shape. The inward extending portion 16 is connected to a front end portion 151 of the frame body portion 15, and linearly extends from the frame body portion 15 toward the side where the detection element 4 is located (in the direction approaching the detection element 4). In the present embodiment, the inward extending portion 16 extends in the opposing direction FD orthogonal to the axial direction CD. In the present embodiment, the inward extending portion 16 is a member linearly extending from the front end portion 151 without being bent, and therefore can be referred to as “linear portion 16”. In addition, the front end portion 151 is a joint portion between the frame body portion 15 and the inward extending portion 16, and forms a bent portion.

The spring portion 18 is connected to an inward end portion 161 that is an end portion of the linear portion 16 on the side where the detection element 4 is located. The spring portion 18 extends from the linear portion 16 toward the rear side BS in the axial direction CD. Further, the spring portion 18 extends in a direction intersecting the axial direction CD. In the present embodiment, the spring portion 18 extends from the inward end portion 161 toward the rear side BS and in the direction approaching the detection element 4. The inward end portion 161 is a joint portion between the linear portion 16 and the spring portion 18, and forms a bent portion.

The element contact portion 181 forms an end portion of the spring portion 18 on the side opposite to a linear-portion-side end portion 183 (inward end portion 161) connected to the linear portion 16. The element contact portion 181 is a portion to be in contact with the electrode terminal portion 30. In addition, the metal terminal member 10 has a bent portion 19 extending from the element contact portion 181 to the frame body portion 15 side.

When the spring portion 18 is in the assembled state in which the spring portion 18 is in contact with the detection element 4, the spring portion 18 is elastically deformed in the direction approaching the frame body portion 15 around the linear-portion-side end portion 183 as a fulcrum, as compared to the case where the spring portion 18 is in the free state. Thereby, the element contact portion 181 and the electrode terminal portion 30 of the detection element 4 are in contact with each other such that the element contact portion 181 presses the electrode terminal portion 30. Therefore, even when an external force such as an impact is applied to the sensor 2, the possibility of the element contact portion 181 and the electrode terminal portion 30 being in the non-contact state can be reduced.

As shown in FIG. 5B, a length L18 of the spring portion 18 along a direction in which the spring portion 18 extends is longer than a length L16 of the linear portion 16 along a direction in which the linear portion 16 extends. In addition, the thickness of the linear portion 16 and the thickness of the spring portion 18 are substantially equal to each other. As shown in FIG. 5(A), a width W16 of the linear portion 16 and a width W18 of the spring portion 18 are substantially equal to each other.

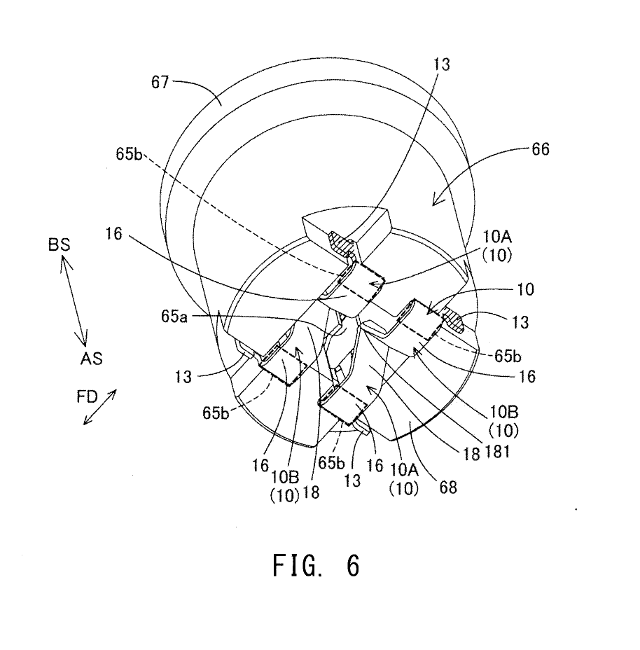

FIG. 6 is a perspective view of the separator 66 in which the metal terminal member 10 is disposed. In each of the four groove portions 65b formed on the inner wall surface of the insertion portion 65a of the separator 66, the metal terminal member 10 is inserted. Specifically, the frame body portion 15 (FIG. 4) is inserted in the four groove portions 65b. The linear portion 16 is disposed so as to protrude from the front-side end surface 68 of the separator 66 toward the front side AS. The spring portion 18 is folded back from the linear portion 16 to the rear side BS, whereby the element contact portion 181 is disposed inside the insertion portion 65a.

Among the four metal terminal members 10, the two metal terminal members 10 having the engagement portions 13 with single-hatching are in contact with the two electrode terminal portions 31, 32 (FIG. 2) electrically connected to the detection portion 8 that functions as an oxygen concentration cell. The remaining two of the four metal terminal members 10 are in contact with the two electrode terminal portions 34, 36 (FIG. 2) electrically connected to the heat generating portion 50a and the electrode terminals 50b, 50c. The spring portions 18 of the two metal terminal members 10 are disposed so as to oppose each other across the detection element 4. In the state before the detection element 4 is assembled (pre-assembling state), the opposed element contact portions 181 are in contact with each other. Since the detection element 4 is pressed by the elastic force of the spring portion 18, the interval between the opposed element contact portions 181 in the pre-assembling state is smaller than the thickness of the detection element 4.

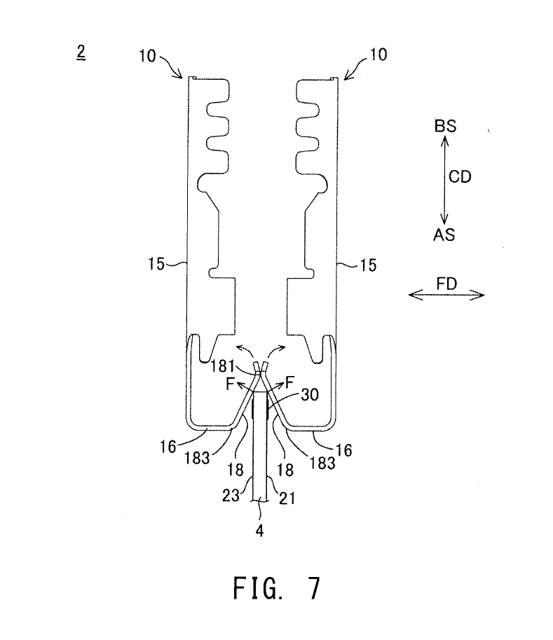

FIG. 7 is a diagram for explaining a method of manufacturing the sensor 2. First, a first assembly obtained by assembling the separator 66, the holding member 69, the metal terminal members 10, and the lead wires 46 (FIG. 1), and a second assembly obtained by assembling the metal shell 38, the crimping packing 57, the ceramic sleeve 6, the powder-charged layer 53, and the ceramic holder 51, are prepared. Then, the rear-side portion of the detection element 4 included in the second assembly is inserted into the insertion portion 65a (FIG. 6) of the separator 66 included in the first assembly, along the axial direction CD toward the rear side BS, such that the electrode terminal portion 30 comes into contact with the element contact portion 181. Assembling of other members is performed after insertion of the detection element 4 into the insertion portion 65a and contact of the electrode terminal portion 30 to the element contact portion 181 are completed. For example, the outer casing 44, the outer protector 42, and the inner protector 43 are mounted to the metal shell 38 by laser beam welding. In addition, the grommet 50 is fixed in the outer casing 44 by, for example, crimping the rear-side opening of the outer casing 44 in which the grommet 50 is disposed.

In the process of assembling the detection element 4 until the electrode terminal portion 30 and the element contact portion 181 are brought into contact with each other by moving the detection element 4 from a position on the front side AS relative to the metal terminal member 10 toward the rear side BS, the detection element 4 comes into contact with the spring portion 18 to apply an external force F to the spring portion 18. This external force F includes a component of a direction which is orthogonal to the axial direction CD and in which the spring portion 18 moves to the frame body portion 15. Due to this external force F, the spring portion 18 is elastically deformed so as to approach the frame body portion 15 side around the linear-portion-side end portion 183 as a fulcrum. The elastic deformation of the spring portion 18 causes the position of the element contact portion 181 to move along the axial direction CD. As compared to the conventional sensor having no linear portion 16, the sensor 2 according to the present embodiment can reduce the amount of movement of the element contact portion 181 along the axial direction CD in the assembling process. In addition, the sensor 2 according to the present embodiment can reduce the above-mentioned amount of movement while suppressing an increase in the size of the metal terminal member 10 in the axial direction CD. Hereinafter, the reasons thereof will be specifically described.

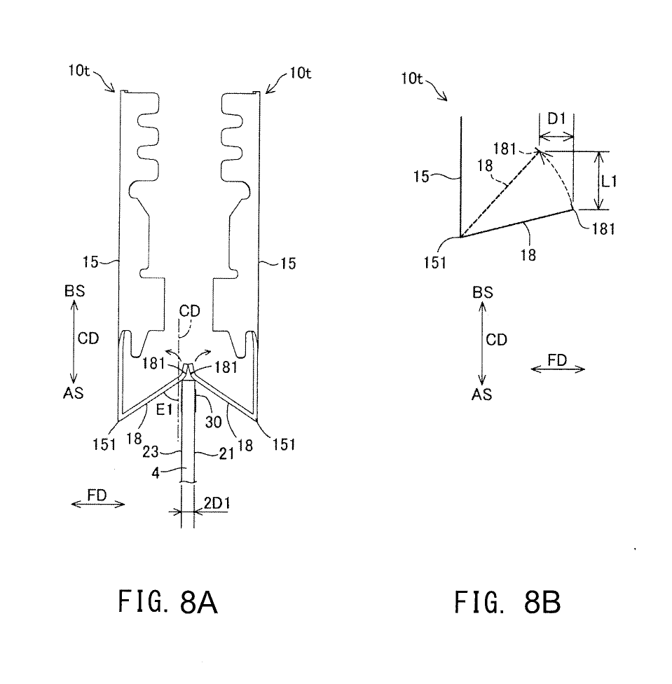

FIGS. 8A-8B are diagrams for explaining a metal terminal member 10t included in the conventional sensor. FIG. 8A is a diagram for explaining the structure of the metal terminal member 10t, and FIG. 8B is a diagram for explaining the amount of movement of the element contact portion 181. The conventional sensor includes the metal terminal member 10t shown in FIG. 8A instead of the metal terminal member 10 of the present embodiment. The metal terminal member 10t is different from the metal terminal member 10 of the present embodiment in that it does not include the linear portion 16. That is, the spring portion 18 is connected to the front end portion 151 of the frame body portion 15. An angle formed by the axial direction CD and the direction in which the spring portion 18 in the free state extends is an angle E1. As shown in FIG. 8B, when the metal terminal member 10t is shifted from the free state to the state where the detection element 4 is assembled (the state shown by a dotted line), an external force is applied from the detection element 4 to the spring portion 18, whereby the spring portion 18 is elastically deformed around the front end portion 151 as a fulcrum. The element contact portion 181 moves in accordance with a thickness 2D1 of the detection element 4. Specifically, the element contact portion 181 moves to approach the frame body portion 15 by a distance D1 equal to half the thickness 2D1. The amount of movement of the element contact portion 181 along the axial direction CD when the element contact portion 181 moves by the distance D1 is indicated by L1.

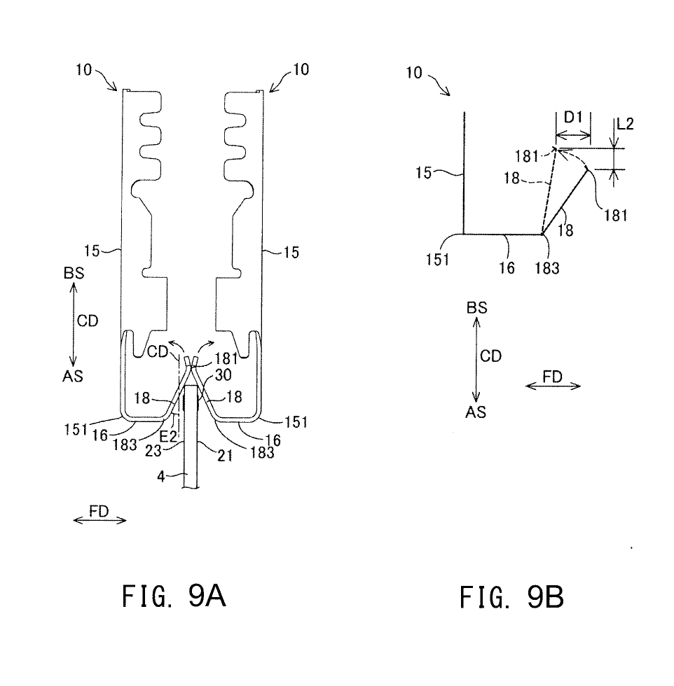

FIGS. 9A-9B are diagrams for explaining the effects. FIG. 9A is a schematic view of the metal terminal member 10 in the free state, and FIG. 9B is a diagram for explaining the amount of movement of the element contact portion 181. A range, in the axial direction CD, in which the element contact portion 181 and the electrode terminal portion 30 are in contact with each other in the sensor 2 has previously been set to a position of a predetermined range, because of other members and the like. As shown in FIG. 9A, the metal terminal member 10 has the linear portion 16 extending from the frame body portion 15 toward the side where the detection element 4 is located. Thus, the degree of folding of the spring portion 18 can be reduced as compared to the spring portion 18 of the conventional metal terminal member 10t. In other words, an angle E2 formed by the axial direction CD and the direction in which the spring portion 18 in the free state extends can be made smaller than the angle E1 shown in FIG. 8A.

When the metal terminal member 10 is shifted from the free state to the state where the detection element 4 is assembled (the state shown by a dotted line) as shown in FIG. 9B, the element contact portion 181 moves so as to approach the frame body portion 15 by the distance D1 which is half the thickness 2D1. Since the angle E2 is smaller than the angle E1, even when the element contact portion 181 has moved by the distance D1 as in the conventional sensor, the amount of movement of the element contact portion 181 along the axial direction CD is L2 which is smaller than L1. Thus, even when the dimension of the electrode terminal portion 30 along the axial direction CD is reduced, it is possible to successfully achieve contact between the electrode terminal portion 30 and the element contact portion 181. Preferably, the angle E2 is not larger than 45 degrees and, more preferably, not larger than 35 degrees. Thus, the amount of movement of the element contact portion 181 along the axial direction CD can be further reduced.

It is also conceivable that the angle E1 can be approximated to the angle E2 by extending the frame body portion 15 in the axial direction CD to locate the front end portion 151 on the front side AS relative to the position shown in FIG. 8A. In this case, however, in order to avoid contact of the metal terminal member 10 with other members (e.g., the metal shell 38), the length of the sensor 2 in the axial direction CD needs to be designed larger than in the conventional sensor. On the other hand, in the present embodiment, the linear portion 16 allows the angle E2 to be smaller than the angle E1, without the necessity of extending the metal terminal member 10 toward the front side AS relative to the conventional metal terminal member 10t. Therefore, it is possible to suppress an increase in the size of the sensor 2 in the axial direction CD.

Further, according to the present embodiment, the length L18 of the spring portion 18 is larger than the length L16 of the linear portion 16 as shown in FIG. 5B. Thus, even when an external force is applied from the detection element 4 to the spring portion 18 in the assembling process, a force applied to the linear portion 16 can be reduced. Therefore, even when the spring portion 18 is elastically deformed, the amount of deformation of the linear portion 16 in the axial direction CD can be suppressed, whereby the amount of movement of the element contact portion 181 in the axial direction CD in the assembling process can be further reduced.

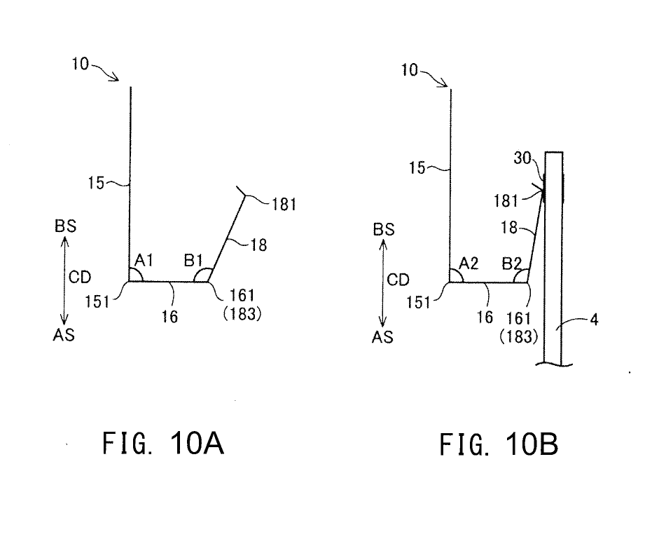

FIGS. 10A-10B are diagrams for further explaining the metal terminal member 10. FIG. 10A is a schematic view of the metal terminal member 10 in the free state, and FIG. 10B is a schematic view of the metal terminal member 10 after the metal terminal member 10 has been assembled as a component of the sensor 2. As shown in FIG. 10A, it is assumed that an angle formed by the frame body portion 15 and the linear portion 16 in the free state is an angle A1 (0°<A<180°), and an angle formed by the linear portion 16 and the spring portion 18 in the free state is an angle B1 (0°<B1<180°). As shown in FIG. 10B, an angle formed by the frame body portion 15 and the linear portion 16 in the state where the metal terminal member 10 is assembled as a component of the sensor 2 is an angle A2 (0°<A2<180°), and an angle formed by the linear portion 16 and the spring portion 18 in the above-mentioned state is an angle B2 (0°<B2<180°). In this case, the sensor 2 according to the present embodiment satisfies the relationship of (B1-B2)>(A1-A2). This sensor 2 can be realized by, for example, making the strength of the front end portion 151 higher than that of the inward end portion 161. Specifically, the strength of the front end portion 151 can be increased by making the thickness of the front end portion 151 larger than that of the inward end portion 161, or by increasing the residual stress of the front end portion 151. The residual stress of the front end portion 151 can be increased by making the angle Al greater than the angle B1 by bending a linear plate member. Since the amount of change (A1-A2) of the angle formed by the linear portion 16 and the spring portion 18 is small as described above, displacement of the linear portion 16 in the axial direction CD can be further reduced. Thus, the amount of movement of the element contact portion 181 in the axial direction CD can be further reduced in the assembling process for the detection element 4.

B. Alternative Embodiments of Metal Terminal Member

The metal terminal member according to the present invention may have a configuration different from the metal terminal member 10 according to the above embodiment, as long as the metal terminal member has the linear portion 16 extending from the frame body portion 15 in the direction approaching the detection element 4. Alternative embodiments of the metal terminal member will be described below.

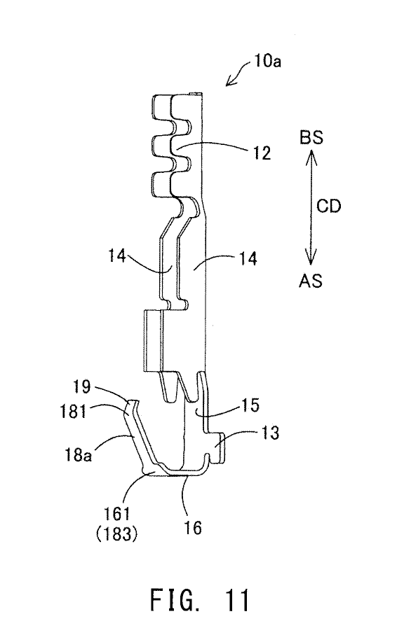

FIG. 11 is a perspective view of a metal terminal member 10a according to a first alternative embodiment. The metal terminal member 10a is different from the metal terminal member 10 (FIG. 3) of the first embodiment in the widths of a spring portion 18a and the bent portion 19. Since other components are the same as those of the first embodiment, the same components as those of first embodiment are designated by the same reference numerals, and the description thereof is omitted. In the metal terminal member 10a, the widths of the spring portion 18a and the bent portion 19 are smaller than the width of the linear portion 16. Even in this case, since the metal terminal member 10a has the linear portion 16 as in the above embodiment, the amount of movement of the element contact portion 181 in the axial direction CD when the electrode terminal portion 30 is brought into contact with the element contact portion 181, can be reduced. Accordingly, the dimension of the electrode terminal portion 30 along the axial direction CD can be reduced. Further, in the metal terminal member 10a, the width of the spring portion 18a is smaller than the width of the linear portion 16. Therefore, as compared to the case where the linear portion 16 and the spring portion 18 have the same width, the amount of deformation of the linear portion 16 can be suppressed even when the spring portion 18a is elastically deformed by a force applied from the detection element 4.

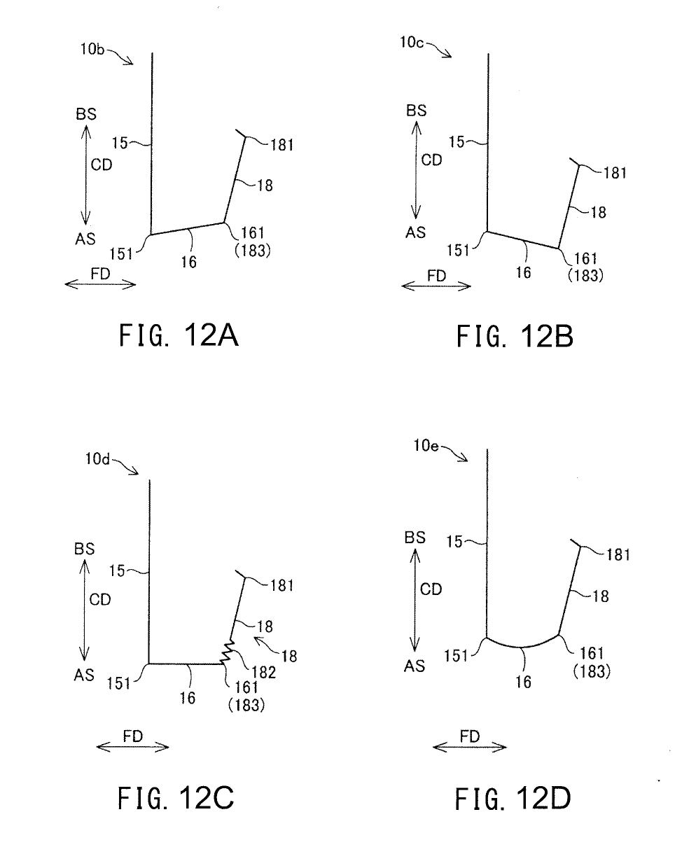

FIGS. 12A-12D are schematic diagrams for explaining second to fifth alternative embodiments of the metal terminal member. FIG. 12A is a schematic view for explaining a metal terminal member 10b according to the second alternative embodiment. FIG. 12B is a schematic view for explaining a metal terminal member 10c according to the third alternative embodiment. FIG. 12C is a schematic view for explaining a metal terminal member 10d according to the fourth alternative embodiment. FIG. 12D is a schematic view for explaining a metal terminal member 10e according to the fifth alternative embodiment. FIGS. 12A to 12D schematically show the metal terminal members 10b to 10e which are assembled in the sensor 2 so as to be in contact with the detection element 4.

The linear portion 16 may not be extended in the horizontal direction (the direction parallel to the opposing direction FD) as long as the linear portion 16 has a shape extending from the front end portion 151 in the direction approaching the detection element 4 side. For example, the linear portion 16 of the metal terminal member 10b shown in FIG. 12A extends from the front end portion 151 in the direction approaching the rear side BS and the detection element 4. Further, for example, the linear portion 16 of the metal terminal member 10c shown in FIG. 12B extends from the front end portion 151 in the direction approaching the front side AS and the detection element 4. Preferably, the linear portion 16 extends in either the direction orthogonal to the axial direction CD or the direction toward the rear side BS along the axial direction CD. Thus, the length of the metal terminal member 10, 10b in the axial direction CD can be controlled, whereby an increase in the size of the sensor 2 can be suppressed.

The spring portion 18 may not have a shape linearly extending from the inward end portion 161. For example, as shown in FIG. 12C, the spring portion 18 may have a bellows-shaped intermediate portion 182 between the linear-portion-side end portion 183 and the element contact portion 181. Further, the spring portion 18 may not have a flat-plate shape, but may have a shape having a curved main surface.

In the above embodiment, the linear portion 16 has a flat-plate shape, and linearly extends from the front end portion 151 in the direction approaching the detection element 4. However, the linear portion 16 may have another shape as long as the linear portion 16 extends from the front end portion 151 toward the side where the detection element 4 is located. In the case where the linear portion 16 does not linearly extend, the member given the reference numeral 16 is referred to as an inward extending portion 16. For example, as shown in FIG. 12D, the inward extending portion 16 may have a shape having a curved main surface.

In the second to fifth alternative embodiments, since the linear portion (inward extending portion) 16 is provided as in the above embodiment, the angle E2 formed by the axial direction CD and the direction in which the spring portion 18 extends in the free state can be reduced. Thus, the amount of movement of the element contact portion 181 in the axial direction CD when the electrode terminal portion 30 is brought into contact with the element contact portion 181, can be reduced.

Further, in the above embodiment and the second to fifth alternative embodiments, preferably, the rigidity of the spring portion 18 is lower than that of the inward extending portion (linear portion) 16. The rigidity of the spring portion 18 can be reduced by, for example, making the thickness of the spring portion 18 smaller than the thickness of the inward extending portion (linear portion) 16. The magnitude of the rigidity is evaluated according to the following evaluation method. The linear-portion-side end portion 183 as one end portion of the spring portion 18 is fixed, and a constant force Fc is applied to the element contact portion 181 as the other end portion thereof. The force Fc is applied in a direction that elastically deforms the spring portion 18 inward, from a direction perpendicular to the main surface of the element contact portion 181. Displacement of the element contact portion 181 when the force Fc is applied thereto is indicated by C18. In addition, the front end portion 151 as one end portion of the linear portion 16 is fixed, and a constant force Fc is applied to the inward end portion 161 as the other end portion thereof. This force Fc is applied in the direction that elastically deforms the spring portion 18 inward, from the direction perpendicular to the main surface of the inward end portion 161. Displacement of the inward end portion 161 when the force Fc is applied thereto is indicated by C16. When the displacement C18 is larger than the displacement C16, it is evaluated that the spring portion 18 has the rigidity lower than that of the inward extending portion (linear portion) 16.

As described above, in the case where the rigidity of the spring portion 18 is lower than that of the inward extending portion (linear portion) 16, the amount of deformation of the inward extending portion (linear portion) 16 can be suppressed even when the spring portion 18 is elastically deformed due to the force applied from the detection element 4, as compared to the case where the spring portion 18 and the inward extending portion (linear portion) 16 have the same rigidity. Thus, the amount of movement of the element contact portion 181 in the axial direction CD when the electrode terminal portion 30 is brought into contact with the element contact portion 181, can be further reduced.

C. Modifications

The present invention is not limited to the above embodiment and modes and may be embodied in various other forms without departing from the scope of the invention. For example, the following modifications are possible.

In the above embodiment, the end portion of the spring portion 18 forms the element contact portion 181. However, the position of the element contact portion 181 is changeable as long as it is formed in the spring portion 18. For example, the element contact portion 181 may be formed between the inward end portion 161 as one end portion of the spring portion 18 and the other end portion thereof. Alternatively, the element contact portion 181 may be formed by attaching a projection to the spring portion 18.

In the above embodiment, a gas sensor for detecting the concentration of a specific component in a gas to be measured. However, the present invention is not limited thereto. The present embodiment is applicable to various sensors having a metal terminal member which is electrically connected to an electrode terminal portion of a detection element to form a current path. Examples of the various sensors include a pressure sensor and a temperature sensor. In the case of the pressure sensor, the detection element outputs a signal for detecting pressure. In the case of the temperature sensor, the detection element outputs a signal for detecting pressure.

The present invention is not limited to the above embodiments, modes, and modifications/variations and can be embodied in various forms without departing from the scope of the present invention. For example, it is feasible to appropriately replace or combine any of the technical features of the aspects of the present invention described in “Summary of the Invention” and the technical features of the embodiments, modes, and modifications/variations of the present invention in order to solve part or all of the above-mentioned problems or achieve part or all of the above-mentioned effects. Any of these technical features, if not explained as essential in the present specification, may be deleted as appropriate.

### DESCRIPTION OF REFERENCE NUMERALS

2 sensor
4 detection element
6 ceramic sleeve
8 detection portion
10, 10A, 10B, 10a to 10e, 10t metal terminal member
12 lead wire connecting portion
13 engagement portion
14 projecting portion
15 frame body portion
16 inward extending portion (linear portion)
18, 18a spring portion
19 bent portion
21 first plate surface
21a through-hole
21b through-hole
23 second plate surface
23a through-hole
30, 31, 32, 34, 36 electrode terminal portion
30a through-hole
38 metal shell
39 screw portion
40 rear end portion
41a sensing lead portion
42 outer protector
42a sensing lead portion
43 inner protector
44 outer casing
46 lead wire
50 grommet
50a heat generating portion
50b electrode terminal
51 ceramic holder
52 ledge portion
53 talc ring
54 through-hole
57 crimping packing
61 lead wire insertion hole
65a insertion portion
65b groove portion
66 separator
67 flange portion
68 front-side end surface
69 holding member
151 front end portion
161 inward end portion
181 element contact portion
182 intermediate portion
183 linear-portion-side end portion
420 porous layer
421, 422, 423 insulating layer
430 solid electrolyte layer
441 gas-to-be-measured side electrode
442 reference gas electrode
450 heater
460 porous protection layer
W width direction
F external force
D1 distance
A1, A2, B1, B2, E1, E2 angle
CD axial direction
FD opposing direction
CL axis
AS front side
BS rear side
Fc force
W16, W18 width
L16, L18 displacement

1. A sensor comprising:
a detection element having a plate shape extending in an axial direction, the detection element having a front side in the axial direction being directed to a measurement target, and a rear side in the axial direction on which an electrode terminal portion is formed;
a separator having an insertion portion into which the rear side of the detection element is inserted, and a plurality of groove portions extending in the axial direction formed on an inner wall surface of the insertion portion; and
a metal terminal member that is held between the detection element and the separator while being inserted into at least one of the plurality of groove portions, and is electrically connected to the electrode terminal portion to form a current path, wherein
the metal terminal member comprises:
an elongated frame body portion extending in the axial direction;
an inward extending portion connected to a front end portion of the frame body portion, and extending from the frame body portion toward a side where the detection element is located;
a spring portion connected to an inward end portion, which is an end of the inward extending portion located on a side of the detection element, the spring portion extending toward the rear side in the axial direction and intersecting the axial direction; and
an element contact portion formed in the spring portion, and contacting the electrode terminal portion.

2. The sensor according to claim 1, wherein
the spring portion has rigidity lower than that of the inward extending portion.

3. The sensor according to claim 1, wherein
the spring portion and the inward extending portion each have a plate shape, and
the spring portion has a width smaller than that of the inward extending portion.

4. The sensor according to claim 1, wherein
a length of the spring portion in a longitudinal direction is longer than that of the inward extending portion.

5. The sensor according to claim 1, wherein
the inward extending portion is a member linearly extending from the front end portion of the frame body portion.

6. The sensor according to claim 5, wherein
the inward extending portion extends in either a direction orthogonal to the axial direction or a direction toward the rear side in the axial direction.

7. The sensor according to claim 5, wherein
a relationship of (B1-B2)>(A1-A2) is satisfied, where
A1 is an angle formed by the frame body portion and the inward extending portion (0°<A1 <180°) and B1 is an angle formed by the inward extending portion and the spring portion (0°<B1<180°), both A1 and B1 being formed in a free state, and
A2 is an angle formed by the frame body portion and the inward extending portion is an angle A2 (0°<A2<180°) and B2 is an angle formed by the inward extending portion and the spring portion (0°<B2 <180°), both A2 and B2 being formed in a state where the metal terminal member is assembled as a component of the sensor.
